(19) United States
(12) Patent Application Publication
(10) Pub. No.: US 2021/0181860 A1
(43) Pub. Date: Jun. 17, 2021

(54) DISPLAY DEVICE AND METHOD FOR OPERATING SAME

(71) Applicant: WUHAN CHINA STAR OPTOELECTRONICS SEMICONDUCTOR DISPLAY TECHNOLOGY CO., LTD., Wuhan (CN)

(72) Inventor: Jian YE, Wuhan (CN)

(21) Appl. No.: 16/335,258

(22) PCT Filed: Feb. 25, 2019
(86) PCT No.: PCT/CN2019/076031

§ 371 Date: Mar. 21, 2019

(30) Foreign Application Priority Data
Dec. 18, 2018 (CN) 201811553792.X

(51) Int. Cl. G06F 3/02; G06K 9/00

(52) U.S. Cl. CPC G06F 3/0202; G06K 9/0004

(57) ABSTRACT

The present disclosure provides a display device including a display module. The display module includes at least a metal middle frame and a display panel disposed in the metal middle frame; wherein a function area is defined on a top surface of the display panel, a sensing assembly is disposed between the function area of the display panel and the metal middle frame, and the sensing assembly includes at least a fingerprint identification module and a pressure sensing module.

### FIELD OF INVENTION

The present disclosure relates to a field of display technology, and more particularly, to a display device and a method for operating the same.

### BACKGROUND

At present, a fingerprint identification area of smartphones is generally located in a non-display area of phones, and it is generally achieved by independently disposing a fingerprint identification module at a bottom of smartphones. However, this increases an area of the non-display area of the phones, and lowers screen-to-body ratio. In addition, to carry out such a design, it is required to form holes in a cover plate or to thin thickness of the cover plate during manufacturing process of smartphones. This increases process complexity and manufacturing cost of phones. As phones are developed in a direction to have a full-screen design, the screen-to-body ratio is getting higher and an edge frame of phones is getting narrower than before. Thus, there is no space to install a front fingerprint identification module and a “Home” button that functions to return to a home screen on a front side of smartphones.

Because of the demand of the full-screen design, there is no choice that a “Home” button with a fingerprint identification function, which has been used for years, is removed from smartphones, such as IPHONE X launched by APPLE Inc. Instead, three-dimensional (3D) facial recognition technology is used, or fingerprint identification module is modified to be installed on a back side of phones, such as phones launched by HUAWEI TECHNOLOGIES CO., LTD. Nevertheless, for unlocking of phones, users do not have a better experience by use of 3D facial recognition technology than by use of fingerprint identification. Users are still used to use their fingers to press the front fingerprint identification module (also functioning as the “Home” button) to unlock a screen of phones, and after the screen is unlocked, users press the “Home” button having the fingerprint identification function to make phones return to the home screen.

Currently, smartphones having the fingerprint identification function under a display screen appeared on the market, where the fingerprint identification module is attached to a specific area under an active-matrix organic light emitting diode (AMOLED) display screen. As users' fingers press this area of the display screen, a fingerprint identification unlocking function is realized. However, after the screen is unlocked, making phones return to the home screen, it is still required to use users' fingers to initiate a sliding motion on phones. This reduces user experience of smartphones. In particular, for users who use such kinds of phones for the first time, users do not get accustomed to it. Due to unfamiliarity with such an operation, users feel inconvenient in operating phones.

In summary, users do not have an excellent experience by use of a fingerprint identification unlocking function and return-to-home screen function in conventional full-screen phones. There is a need to provide a display device and a method for operating the same to solve problems existing in prior art.

### SUMMARY OF DISCLOSURE

### Technical Problems

The present disclosure provides a display device in order to solve problems existing in prior art, where users do not have an excellent experience by use of fingerprint identification unlocking function and return-to-home screen function in conventional full-screen phones.

### Technical Solutions

To solve the above-said problems, the present disclosure provides the technical schemes below.

The present disclosure provides a display device comprising a display module, the display module comprising:

a metal middle frame;

a display panel disposed in the metal middle frame, wherein a function area is defined on a top surface of the display panel; and

a sensing assembly, disposed between the function area of the display panel and the metal middle frame and comprising at least a fingerprint identification module and a pressure sensing module.

In the display device according to one embodiment of the present disclosure, one side of the fingerprint identification module is attached to a bottom surface of the display panel, and the pressure sensing module is disposed at the other side of the fingerprint identification module.

In the display device according to one embodiment of the present disclosure, the pressure sensing module is a capacitance type pressure sensor.

In the display device according to one embodiment of the present disclosure, the pressure sensing module is disposed on a surface of the metal middle frame, and a gap exists between the pressure sensing module and the fingerprint identification module.

In the display device according to one embodiment of the present disclosure, the pressure sensing module is attached to the other side of the fingerprint identification module, and a gap exists between the pressure sensing module and the metal middle frame.

In the display device according to one embodiment of the present disclosure, the pressure sensing module is a resistance type pressure sensor.

In the display device according to one embodiment of the present disclosure, one side of the pressure sensing module is attached to a surface of the metal middle frame, and the other side of the pressure sensing module is attached to the fingerprint identification module.

In addition, the present disclosure provides a method for operating the above-said display device, comprising:

a step S10 of pressing the function area using a finger of a user, wherein the pressing step includes exerting at least a first force and a second force;

a step S20 of identifying a fingerprint of the user by the fingerprint identification module to unlock a home screen or a payment function if the finger exerts the first force on the function area;

a step S30 of making display interface of the display device return from an application screen to the home screen if the finger exerts the second force on the function area.

In the method for operating the display device according to one embodiment of the present disclosure, the method further comprises: enabling a background application manager if the finger exerts the second force for a first duration.

In the method for operating the display device according to one embodiment of the present disclosure, the first force is less than the second force.

### Advantageous Effects

The present disclosure provides a display device. The pressure sensing module is disposed below the fingerprint identification module. As the finger presses the function area using a smaller force, fingerprint identification unlocking function is realized. On the other hand, as the finger presses this area using a greater force during operation of the phone, return-to-home screen function is realized. Thus, it is convenient for users to operate the phones, and the uses can have an excellent experience of operating same.

### BRIEF DESCRIPTION OF DRAWINGS

To detailedly explain the technical schemes of the embodiments or existing techniques, drawings that are used to illustrate the embodiments or existing techniques are provided. Apparently, the illustrated embodiments are just a part of those of the present disclosure. It is easy for any person having ordinary skill in the art to obtain other drawings without labor for inventiveness.

FIG. 1 shows a cross-sectional view of a display module of a display device according to the present disclosure.

FIG. 2 is a schematic diagram showing a structure of a display panel of the display device according to the present disclosure.

FIG. 3 shows an internal structure of the display device according to the present disclosure.

FIG. 4 shows a cross-sectional view of a display module according to EMBODIMENT ONE of the present disclosure.

FIG. 5 shows a cross-sectional view of a display module according to EMBODIMENT TWO of the present disclosure.

FIG. 6 shows a cross-sectional view of a display module according to EMBODIMENT THREE of the present disclosure.

FIG. 7 is a schematic diagram showing a flowchart of a method for operating the display device according to the present disclosure.

### DETAILED DESCRIPTION

Reference will be made in detail to embodiments of the present disclosure. The same or similar elements and the elements having same or similar functions are denoted by like reference numerals throughout the descriptions. The embodiments described herein with reference to drawings are explanatory, illustrative, and used to generally understand the present disclosure. The embodiments shall not be construed to limit the present disclosure.

The present disclosure solves problems existing in prior art, where users do not have an excellent experience by use of a fingerprint identification unlocking function and a return-to-home screen function in conventional full-screen phones, and users feel inconvenient in operation of phones.

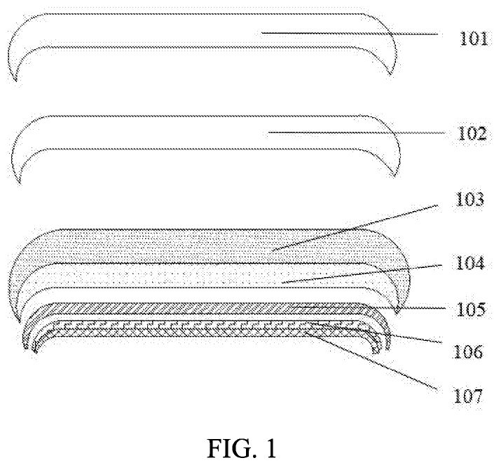

Please refer to FIG. 1, which shows a cross-sectional view of a display module of a display device according to the present disclosure. This figure shows some of the components constituting the display module of the present disclosure. The display module includes at least a cover glass 101, a touch control screen 102 disposed below the cover glass 101, a display panel 103 disposed below the touch control screen 102, and a modular structural assembly disposed below the display panel 103.

In the present embodiment, the display panel 103 is an active-matrix organic light emitting diode (AMOLED) display screen. The modular structural assembly includes at least a supporting film 104, a buffer layer 105, a graphite heat dissipation sheet 106, and a copper foil shielding layer 107.

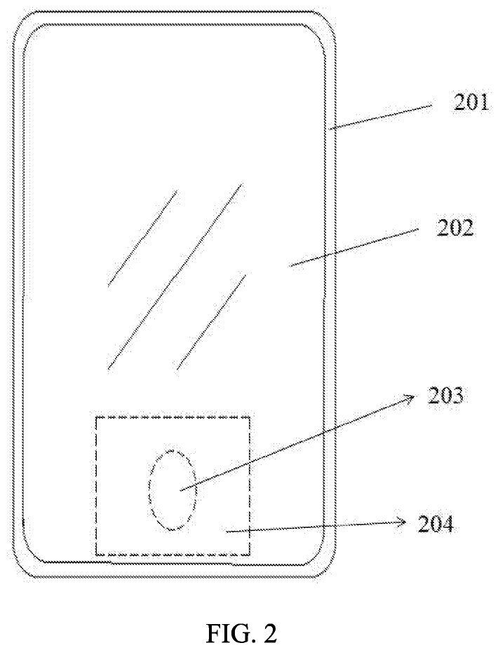

Please see FIG. 2, which is a schematic diagram showing a structure of the display panel of the display device according to the present disclosure. The display device includes the display module. The display module includes at least a metal middle frame 201 and a display panel 202 disposed in the metal middle frame 201. A fingerprint identification module, which is used to carry out fingerprint identification in a screen, is disposed below the display panel 202. A pressure sensing module is disposed below the fingerprint identification module. A fingerprint identification area in the screen (i.e., a function area) 204 also functions as a virtual “Home” button. A working principle thereof is based on pressure sensitivity. As a finger 203 presses this area using a smaller force, the fingerprint identification unlocking function is realized. On the other hand, as the finger 203 presses this area with a greater force during the operation of the phone, the return-to-home screen function is realized, that is realizing the same function as a “Home” button if pressed by a greater force. Therefore, different functions can be achieved by different degree of forces exerted thereon.

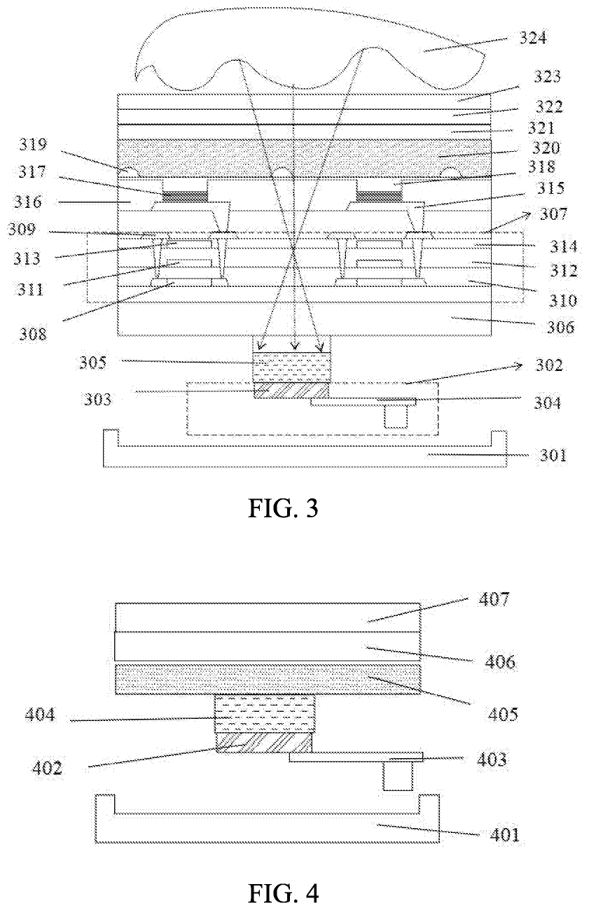

Please refer to FIG. 3, which shows an internal structure of the display device according to the present disclosure. This figure shows the components constituting the display device of the present disclosure. The display module includes at least a metal middle frame 301 and the display panel disposed in the metal middle frame 301. A sensing assembly is disposed between the display panel and the metal middle frame 301. The sensing assembly includes the pressure sensing module 302 and the fingerprint identification module 305. The pressure sensing module 302 includes a pressure sensor 303 and a flexible printed circuit board (PCB) 304. The display panel includes:

an alignment film 306;

a thin film transistor (TFT) array 307, wherein the TFT array 307 includes the buffer layer formed on the alignment film 306, an active layer 308 and a source/drain electrode 309 formed on the buffer layer, a first gate insulation layer 310 formed on the active layer 308, a first gate electrode 311 formed on the first gate insulation layer 310, a second gate insulation layer 312 formed on the first gate electrode 311, a second gate electrode 313 formed on the second gate insulation layer 312, and an interlayer dielectric layer 314 formed on the second gate electrode 313;

a liquid crystal display, wherein the liquid crystal display includes a passivation layer formed on the TFT array 307, an anode metal layer 315 formed on the passivation layer, a pixel defining layer 316, an organic light-emitting layer 317 formed on the anode metal layer 315, a cathode metal layer 318 formed on the organic light-emitting layer 317, a spacer post 319, a thin film encapsulation layer 320, and a polarizer sheet 321;

an optically clear adhesive 322 disposed on the polarizer sheet 321; and

a cover glass 323 disposed on the optically clear adhesive 322.

In the present embodiment, the organic light-emitting layer 317 emits light, which is reflected back by a user's finger 324. Since light reflected from valleys and ridges of the user's finger 324 requires a different distance to reach the fingerprint identification module 305, the timing that the fingerprint identification module 305 receives reflected light is different. Thus, the fingerprint identification unlocking function or fingerprint payment function can be realized based on different fingerprints of different users. In addition, because the pressure sensing module 302 is disposed below the fingerprint identification module 305, as the finger 324 presses the fingerprint identification area using a smaller force, the fingerprint identification unlocking function is realized. On the other hand, as the finger 324 presses this area using a greater force during operation of the phone, the return-to-home screen function is realized, that is realizing the same function as the “Home” button if pressed by greater force. Preferably, a background application manager is enabled if the finger 324 exerts a greater force to press this area for a first duration.

Please see FIG. 4, which shows a cross-sectional view of the display module according to EMBODIMENT ONE of the present disclosure. This figure shows the components constituting the display module, and shows a relative position relationship between the components. The display device includes the display module. The display module includes at least a metal middle frame 401 and a display panel 405 disposed in the metal middle frame 401. The function area is defined on a top surface of the display panel 405. The sensing assembly is disposed between the function area of the display panel 405 and the metal middle frame 401. The sensing assembly includes at least a fingerprint identification module 404 and a pressure sensing module 402. A touch control screen 406 and a cover glass 407 are disposed on the display panel 405. One side of the fingerprint identification module 404 is attached to a bottom surface of the display panel 405. The pressure sensing module 402 is disposed at the other side of the fingerprint identification module 404.

The pressure sensing module 402 is a capacitance type pressure sensor. A flexible printed circuit board 403 is connected to the capacitance type pressure sensor. The capacitance type pressure sensor is disposed on a surface of the metal middle frame 401. A gap exists between the pressure sensor and the fingerprint identification module 404. The capacitance type pressure sensor is based on a principle of self capacitance or mutual capacitance, wherein a film or a flexible printed circuit board is used as a single-layered sensor, and the pressure sensing module 402 is attached to a back side of the fingerprint identification module 404. In operation, if the finger presses the function area (i.e., an area where the fingerprint identification module is located), the flexible printed circuit board 403 can detect a capacitance change of a cathode between the pressure sensing module 402 and the metal middle frame 401, and thus determines the degree of applied force. If the applied force is greater than a threshold value, the phone can be directly returned to the home screen without the need to utilize a fingers' sliding motion to make the phone return to the home screen.

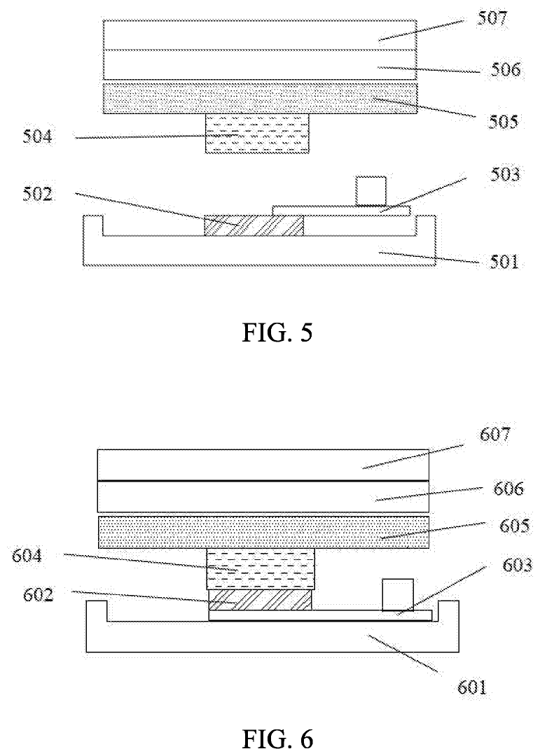

Please see FIG. 5, which shows a cross-sectional view of the display module according to EMBODIMENT TWO of the present disclosure. This figure shows the components constituting the display module, and shows a relative position relationship between the components. The display device includes the display module. The display module includes at least a metal middle frame 501 and a display panel 505 disposed in the metal middle frame 501. A function area is defined on a top surface of the display panel 505. A sensing assembly is disposed between the function area of the display panel 505 and the metal middle frame 501. The sensing assembly includes at least a fingerprint identification module 504 and a pressure sensing module 502. A touch control screen 506 and a cover glass 507 are disposed on the display panel 505. One side of the fingerprint identification module 504 is attached to a bottom surface of the display panel 505. The pressure sensing module 502 is disposed at the other side of the fingerprint identification module 504.

The pressure sensing module 502 is a capacitance type pressure sensor. A flexible printed circuit board 503 is connected to the capacitance type pressure sensor. The capacitance type pressure sensor is attached to the other side of the fingerprint identification module 504. A gap exists between the capacitance type pressure sensor and a surface of a metal middle frame 510. The capacitance type pressure sensor is based on the principle of self-capacitance or mutual capacitance, wherein a film or a flexible printed circuit board is used as a single-layered sensor, and the pressure sensing module 502 is attached to the metal middle frame 501 under an area where the fingerprint identification module 504 is disposed. In operation, if the finger presses the function area (i.e., the area where the fingerprint identification module is located), the flexible printed circuit board 503 can detect a capacitance change of a cathode between the pressure sensing module 502 and the display panel 505, and thus determines the degree of applied force. If the applied force is greater than a threshold value, the phone can be directly returned to the home screen without the need to utilize a fingers' sliding motion to make the phone return to the home screen.

Please see FIG. 6, which shows a cross-sectional view of the display module according to EMBODIMENT THREE of the present disclosure. This figure shows the components constituting the display module, and shows relative position relationship between the components. The display device includes the display module. The display module includes at least a metal middle frame 601 and a display panel 605 disposed in the metal middle frame 601. A function area is defined on a top surface of the display panel 605. A sensing assembly is disposed between the function area of the display panel 605 and the metal middle frame 601. The sensing assembly includes at least a fingerprint identification module 604 and a pressure sensing module 602. A touch control screen 606 and a cover glass 607 are disposed on the display panel 605. One side of the fingerprint identification module 604 is attached to a bottom surface of the display panel 605. The pressure sensing module 602 is disposed at the other side of the fingerprint identification module 604.

The pressure sensing module 502 is a resistance type pressure sensor. A flexible printed circuit board 603 is connected to the resistance type pressure sensor. One side of the resistance type pressure sensor is attached to a surface of the metal middle frame 601. The other side of the resistance type pressure sensor is attached to the fingerprint identification module 604. In operation, if the finger presses the function area (i.e., the area where the fingerprint identification module is located), the flexible printed circuit board 603 can detect resistance change of the resistance type pressure sensor to determine the applied force on the screen. If the applied force is greater than a threshold value, the phone can be directly returned to the home screen without the need to utilize fingers' sliding motion to make the phone return to the home screen.

Correspondingly, the resistance type pressure sensor can be a pressure sensitive resistance type sensor. The pressure sensitive resistance type sensor is a pressure sensitive resistor based on quantum tunneling composites. With applied force on the pressure sensitive resistor getting greater, distance between conductive particles is getting shorter, and barrier between particles is lowered. Because of quantum tunneling effect, electron migration is increased, resistance is lowered, and analogical signals are converted to digital signals.

Correspondingly, the resistance type pressure sensor can be a strain type pressure sensor. Because mechanical deformation occurs on resistance wire of metal strain gauge due to external force, resistance of the resistance wire changes. When resistance wire is stretched, resistance is increased. When resistance wire is compressed, resistance is decreased.

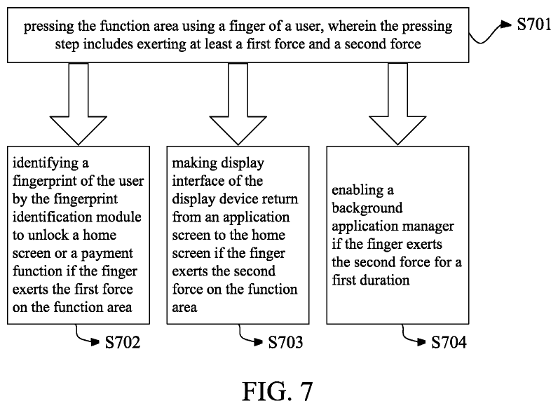

Please refer to FIG. 7, which is a schematic diagram showing a flowchart of a method for operating the display device according to the present disclosure. The method for operating the display device includes:

a step S701 of pressing the function area using a finger of a user, wherein the pressing step includes exerting at least a first force and a second force;

a step S702 of identifying a fingerprint of the user by the fingerprint identification module to unlock a home screen or a payment function if the finger exerts the first force on the function area;

a step S703 of making a display interface of the display device return from an application screen to the home screen if the finger exerts the second force on the function area.

The method further includes a step S704 of enabling a background application manager if the finger exerts the second force for a first duration.

Correspondingly, the first force is less than the second force.

Accordingly, the present disclosure provides the display device. The pressure sensing module is disposed below the fingerprint identification module. As the finger presses the function area using a smaller force, a fingerprint identification unlocking function is realized. On the other hand, as the finger presses this area using a greater force during operation of the phone, a return-to-home screen function is realized. Thus, it is convenient for users to operate the phones, and the uses can have an excellent experience of operating the same. The present disclosure solves problems existing in prior art, where users do not have an excellent experience by use of the fingerprint identification unlocking function and the return-to-home screen function in conventional full-screen phones, and users feel inconvenient in operation of phones.

Detailed description has been provided above for a display device and a method for operating same according to the present disclosure. It is understood that the embodiments provided herein are just examples used to facilitate understanding of the present invention, and should not be construed as limiting of the present disclosure.

What is claimed is:

1. A display device comprising a display module, the display module comprising:
a metal middle frame;
a display panel disposed in the metal middle frame, wherein a function area is defined on a top surface of the display panel; and
a sensing assembly, disposed between the function area of the display panel and the metal middle frame, and comprising at least a fingerprint identification module and a pressure sensing module.

2. The display device according to claim 1, wherein one side of the fingerprint identification module is attached to a bottom surface of the display panel, and the pressure sensing module is disposed at the other side of the fingerprint identification module.

3. The display device according to claim 2, wherein the pressure sensing module is a capacitance type pressure sensor.

4. The display device according to claim 3, wherein the pressure sensing module is disposed on a surface of the metal middle frame, and a gap exists between the pressure sensing module and the fingerprint identification module.

5. The display device according to claim 3, wherein the pressure sensing module is attached to the other side of the fingerprint identification module, and a gap exists between the pressure sensing module and the metal middle frame.

6. The display device according to claim 2, wherein the pressure sensing module is a resistance type pressure sensor.

7. The display device according to claim 6, wherein one side of the pressure sensing module is attached to a surface of the metal middle frame, and the other side of the pressure sensing module is attached to the fingerprint identification module.

8. A method for operating the display device of claim 1, comprising:
a step S10 of pressing the function area using a finger of a user, wherein the pressing step includes exerting at least a first force and a second force;
a step S20 of identifying a fingerprint of the user by the fingerprint identification module to unlock a home screen or a payment function if the finger exerts the first force on the function area;
a step S30 of making a display interface of the display device return from an application screen to the home screen if the finger exerts the second force on the function area.

9. The method according to claim 8, further comprising:
enabling a background application manager if the finger exerts the second force for a first duration.

10. The method according to claim 8, wherein the first force is less than the second force.
